(19) United States
(12) Patent Application Publication
(10) Pub. No.: US 2015/0010891 A1
(43) Pub. Date: Jan. 8, 2015

(54) Behavioral Improvement Method and Reward System

(71) Applicant: Alvaro S. Gomez, West Hempstead, NY (US)

(72) Inventor: Alvaro S. Gomez, West Hempstead, NY (US)

(21) Appl. No.: 13/935,895

(22) Filed: Jul. 5, 2013

(51) Int. Cl. G09B 19/00

(52) U.S. Cl. CPC G09B 19/00
USPC 434/238

(57) ABSTRACT

A behavioral modification method and scoring system are disclosed. The method gives adults and children the process and framework to improve children's understanding of behavioral statements over time. The scoring system tracks their improvements on applying the behavioral statements, and provides the basis for rewards.

### FIELD OF THE INVENTION

The present invention relates generally to an educational method that teaches children moral values by means of having children repeatedly writing numerous times a Good Behavioral Statement we want them to learn, follow a process towards understanding the Good Behavioral Statement, the reason why their behavior needs to be changed, and tracking through a points system their behavioral improvement as it relates to the Good Behavioral Statements.

### BACKGROUND OF THE INVENTION

A healthy functionally sound society is a product of the collective values, beliefs and ethics of its adult citizens. Research in child development and learning theory points to the developing child as the key to behavior as an adult.

The developing child looks to the adults in its life for guidance as to values, beliefs, and ethics. Typically the most influential adults are the parents. However, in today's fast paced and fragmented society, it is difficult for parents to know how to effectively pass core values and socially appropriate behaviors to their children. Today's parents are emotionally stressed, physically rushed, and often lacking a structure within which they can effectively deal with the uniqueness of their children's personalities and behavior.

The present invention was devised primarily for giving parents tools for enhancing the development of children in the four to twelve year old range into responsible adults. The effective development of children of this age range into socially responsible and effective individuals is critical to the social and political health and stability of a nation. Motivation and guidance is a major factor in the effective development of desirable behavior traits in a subject in children and young adults. Reward is one of the most effective motivating factors for inducing a mode of behavior.

### BRIEF SUMMARY OF THE INVENTION

Linking real life experiences with the values we want to teach them, brings focused awareness to our kids. The educational method presented in this patent brings awareness to children by having children associate a bad behavior with its consequences. It uses real life examples on how bad behavior affects their life and the lives of those around them. It also teaches them the effect of good behavior in their lives and how good behavior will affect their lives and the lives of those around them.

By writing the same Good Behavioral Statement numerous times the child maintains a focused attention to the Good Behavioral Statement to be learned, and has higher chances of remembering that Good Behavior in the future and its effect on their life. Repetition is our natural learning process as it improves our memory and retention of information.

This method provides a framework to aid our natural learning processes, and a game-like score system to keep the children motivated.

By writing, or orally explaining, the reasons why it's better to display a good behavior and what behavior she needs to change, the child has higher chances to remember and display the good behavior in the future. Memory is best achieved by repetition; therefore continuous repetition accelerates the memory process.

Every time a child displays the same, or a new, behavior we want to modify the child is sent to the board and the method is applied again. This method is applied until the behavior is modified. This repetition process speeds up the memory storage that helps us retrieve the information from our memory faster and more regularly.

The Board has been designed to provide a tool to keep the children focused on the Good Behavioral Statement as well as keeping track of their good and bad behaviors as explained below.

The educational method helps keep track on how each child is progressing on learning the good behaviors and moral values. It can also show rewards to be achieved once a Good Behavior is learned or how behavior has been improved over time.

The method can keep track of instances of unwanted behavior for each child, and what's the “Overall Behavioral Score” for each child. The “Overall Behavioral Score” in the main embodiment is referred to as the “Moral Compass Score” or “MC Score”. This “MC Score” is defined as “degrees of separation” from the “Correct Behavior—Moral North”, or perfect Moral Compass Score of 0.

A discussion of the related art of which the present inventor is aware, and its differences and distinctions from the present invention, is provided below.

U.S. Pat. No. 6,547,245 issued on Apr. 15, 2003 to Christopher O. Olutunfese, titled “Educational game”, describes an educational game for teaching verses from the bible in an entertaining manner. The educational game includes a game board. A game path is on the game board. The game is won by being the first player to move their token to the finish space.

In contrast, the presented method is religion agnostic, follows no game path, and there is no end to the learning process or game. The scores for each child changes every period of time depending on their behavior. The Score for each child is kept on a chart to be used as starting point during the next period of time, and reviewed every new period of time.

U.S. Pat. No. 5,639,242 issued on Jun. 17, 1997 to Laura Lee Wilson, titled “Children's educational daily responsibilities learning system in game format”, describes an educational device for motivating, monitoring and rewarding children's task performance or the like. This invention relates generally to educational devices, and specifically to a unique, simple and fun learning system that motivates, monitors and reinforces children's performance of daily household chores, tasks and responsibilities.

In contrast, the presented method rewards good behavior, but also punishes bad behavior for unwanted actions by adding points to that child's scoreboard. In addition, with the presented method all children participating are equally measured on each and all Good Behavioral Statements, whereas in U.S. Pat. No. 5,639,242 each child is assigned to a chore or act they must perform. The method presented in this patent application also utilizes a repetition technique that aids memorization and retention of information. In addition the presented method maintains a score used to track each child's behavior, compete with the rest of the children in the environment, and measure improvements from the previous Overall Behavioral Score.

U.S. Pat. No. 5,190,459 issued on Mar. 2, 1993 to Jeffery B. Determan, titled “Child's behavioral calendar apparatus”, A behavioral calendar structure is arranged to include a support plate mounting an upper housing and lower housing thereto. The upper housing includes a first“W” shaped loop to accommodate one counting sphere for each day per week. A second inverted “U” shaped loop mounted to the second housing includes second spheres to accommodate four more spheres to indicate a corresponding number of misbehaviors of a number of days per week. A total of four more displacements of the second spheres effects the displacement in a week of one of a third sphere of a third loop to indicate a single week's behavior. Misbehavior of three or more such spheres effects displacement of the “W” shaped spheres to indicate in a calendar year the number of months of misbehavioral activity. A fourth inverted “U” shaped loop mounted to the second housing is arranged for calendar months corresponding movement of a single sphere per month to indicate whether a child has misbehaved a greater number of months and the current calendar month as indicated by the fourth loop.

In contrast, the presented method uses two methods to manage children behavior. First the child has to spend time learning the Good Behavioral Statement by writing it repeatedly every time they displayed unwanted behavior, as well as answering the questions “why is it important?” and “what do I need to change in my behavior?” Secondly, it accumulates or deducts points when a child behaves in a desired or undesired manner respectively during a specific period of time.

Points are accumulated or deducted every period and not added up in a weekly or monthly sphere. Therefore, the presented method has, at any given point, the focus on only one score per Good Behavioral Statement and one Overall Behavioral Score per child that measures where that child's behavior status is at any given point, accumulated from historical behavior. The presented method doesn't include a system where a determined number of points will accumulate points at a different sphere level, such as weekly or monthly, but presents a linear and perpetual score system that is easy to understand by all participating children. In addition the presented method is not a calendar, and focuses on one present Overall Behavioral Score to reward children.

U.S. Pat. No. 4,776,799 issued on Oct. 11, 1988 to Susan M. Walsh, titled “Portable, self-contained, educational-organizational system and method employing such system”, The system of this invention comprises a system body which, in the open position, has a longitudinally-extending, substantially flat configuration for hanging the system onto a vertical support surface. The system includes at least one visually-coded activity marker means arranged on a side of the system for listing on a daily activity listing means at least one designated daily activity to be performed by said user. This produces a completed daily activity listing means. A plurality of completed daily activity listing means arranged on the system side together comprise an organized educational plan. Also in the system are visually-coded indicator means for evidencing the completion status of each designated daily activity. This allows for recognition by the user of the completion of a series of given activities which make-up the plan.

In contrast, the presented method doesn't have a goal to perform a task over a period of time, moving a bead from the “Do” area to the “Done” area, but records an ongoing commitment from all the children to behave properly over continuous periods of time as it relates to each of the Good Behavioral Statements. In addition, the child has to spend time learning the Good Behavioral Statement by writing it repeatedly every time they displayed unwanted behavior, as well as answering the questions “why is it important?” and “what do I need to change in my behavior?” In addition, in the presented method the subject matter is not chores but behavioral values.

U.S. Pat. No. 3,782,009 issued on Jan. 1, 1974 to Eula K. Darnell, titled “BEHAVIOR MODIFICATION POINT BOARD”, A device is described for keeping records of a point system for rewarding students for desirable classroom behavior and scholastic achievement. At the end of a day, all the student's markers, which he has accumulated, are then placed in his envelope, or exchanged for a marker of a larger denomination and placed in his envelope. The student's envelope will then contain an accumulation of points earned which, in accordance with the particular incentive system employed, may be exchanged for a treat or favor.

In contrast, the presented method makes the child spend time learning the Good Behavioral Statement by writing it repeatedly every time they displayed unwanted behavior, as well as answering the questions “why is it important?” and “what do I need to change in my behavior?” In addition, in the presented method the points are given for bad behavior, not achievements, and only the children with 0 points or the lowest overall score of all participating children will get rewarded for their behavior, instead of rewarding every child that has accumulated/deducted points. In addition the presented method is to be used at home, classroom, daycare or any other environment where the children spend time. In addition, in the presented method each child is being measured against the rest of the children in that environment, as the goal is to have the lowest Overall Behavioral Score or an Overall Behavioral Score or 0. Therefore the Compass or Points Meter where all children's Overall Behavioral Score are plotted and visible against each other.

U.S. Pat. No. 3,862,615 issued on Jan. 28, 1975 to Shu-Lien Liou, titled “APPARATUS FOR CONTROLLING PROGRESS OF A TASK”, an apparatus for controlling the progress of a task defined by at least one task element is disclosed comprising a progress control board which includes at least one task section. Each task section includes a time scale, a plurality of operation step or task element tags positionable relative to the time scale for scheduling the completion of the task element relative to the time scale.

In contrast, the presented method makes the child spend time learning the Good Behavioral Statement by writing it repeatedly every time they displayed unwanted behavior, as well as answering the questions “why is it important?” and “what do I need to change in my behavior?” In addition, in the presented method the task is not relative to the time scale for scheduling the completion of the task element relative to the time scale. Secondly, it accumulates or deducts points when a child behaves in a desired or undesired manner respectively during a specific period of time and has a cumulative Overall Behavioral Score.

U.S. Pat. No. 4,384,855 issued on May 24, 1983 to Belva L. Walsh, titled “Educational task recorder for children”, An educational device for recording children's achievements in performing tasks or the like. The device is comprised of a housing having a plurality of horizontal rows of sight openings. Underlying marking strips present in the first opening in each row a pictorial or word designation of the task or achievement while the following openings present a blank markable portion of the strips registered with a series of openings representing different time periods, such as days of the week, and end openings provide a summation portion of the strip. The housing has slots receiving the marking strip registrable with the rows of openings in the housing. The strip is viewed through the housing openings. Additional marking strips are carried in storage slots behind the slideout marking strip. For simplicity in construction and to provide adaptability in size and capacity, the housing is formed in a modular fashion with each row of housing openings and the slots for the slide-out strips being contained in separate modules.

In contrast, the presented method makes the child spend time learning the Good Behavioral Statement by writing it repeatedly every time they displayed unwanted behavior, as well as answering the questions “why is it important?” and “what do I need to change in my behavior?”. In addition the presented method us used to teach behaviors instead of ensure tasks are being performed. In addition, in the presented method each child is being measured against the rest of the children in that environment, as the goal is to have the lowest Overall Behavioral Score or an Overall Behavioral Score of 0. Therefore the Compass or Points' Meter where all children's Overall Behavioral Score are plotted and visible against each other's score.

U.S. Pat. No. 4,449,710 issued on May 22, 1984 to Norman A. Davis, titled “ Game board, die and reward determining game apparatus”, Game apparatus designed specifically for use as a teaching tool to reward participants for “correct” responses to life situation problems and including a game board having a winner's circle and a plurality of ramps leading radially into the circle, each of said ramps having a plurality of color coded spaces, said game apparatus also including a selection die having color coded surfaces thereon certain of which match the colors of said ramp spaces and certain of said die surface colors determining the action that participant should take. Said game apparatus also includes a play book having preselected life situation problems with multiple choice responses, choosing the “correct” response entitling the participant to a reward, said game apparatus also including a reward selection spinner with a reward selection board, each having matching indicia to determine the specific reward.

In contrast, the presented method makes the child spend time learning a Good Behavioral Statement by writing it repeatedly every time they displayed an unwanted behavior, as well as answering the questions “why is it important?” and “what do I need to change in my behavior?” as it relates to a specific real life situation that has happened to them during that period of time. In addition, in the presented method each answer is not picked from a multiple choice responses but needs to be associated to the behavior they displayed in contrast to the Good Behavioral Statement they just repeatedly wrote. In addition, the presented method tracks scores over time, accumulating points in a linear and perpetual score system.

U.S. Pat. No. 4,216,594 issued on Aug. 12, 1980 to Cheryl Farley, titled “ Psychotherapeutic testing game”, psychotherapeutic testing game comprises a game apparatus for providing a game playing atmosphere between a tester and a player. A chance selection device is associated with the game apparatus for selecting the game participation requirements of a player. A plurality of cards for selection by the game selection device contains information to elicit a personal psychological response of a player whereby the player upon giving the response is given an award operably associated with the game apparatus . . . The present invention provides a desirable approach in working with a younger age group (from approximately 6-14 years old) by combining the creative aspects of play and art therapy with a structured game. The resultant therapeutic creative game is used as a method of engaging the withdrawn or uncooperative child into therapeutic involvement and simultaneously serving as a diagnostic aid for the therapist.

In contrast, the presented method is to be used with a child or group of children, whether they require psychotherapeutic testing or not, and is not serving as a diagnostic aid for a therapist but as an educational method for all parents, educators, guardians and alike. In addition the presented method doesn't use a card system, nor a chance selection device, since answers are specific to the behavior displayed and Good Behavioral Statement we want to teach the children.

U.S. Pat. No. 4,741,701 issued on May 3, 1988 to Steven A. Kossor, titled “Apparatus for providing visual feedback concerning behavior”, A behavior monitoring and status reporting (“feedback”) device, and the method of its use, are disclosed. The device gives visual feedback to a person concerning his or her behavior, along a continuous or discrete interval scale. The user moves an indicator to show the current status of the monitored person's behavior as the person completes each of a series of objectives or satisfies other criteria to justify the receipt of rewards or penalties. The apparatus is intended for use in two primary applications, among others. In the first application, a series of objectives to be achieved by the person being monitored is defined by the user of the device, and posted on a removable panel. The indicator is then moved to the position opposite each objective as the objective is achieved. After the last objective is achieved, a reward is given. In the second application, the removable panal is partitioned into areas, each area (except the top-most area) being assocaited with a particular class of undesirable behaviors. When the person being monitored displays undesirable behavior, the indicator is moved into the area corresponding to the level of undesirable behavior displayed, and a predetermined penalty is administered.

In contrast, the presented method doesn't provide the reward “After the last objective is achieved” but considers a cumulative of behaviors for a period of time and over time. A child may have misbehaved in one specific aspect but be good overall and still get rewarded. In addition, the presented method makes the child spend time learning a Good Behavioral Statement by writing it repeatedly every time they displayed an unwanted behavior, as well as answering the questions “why is it important?” and “what do I need to change in my behavior?”. In addition to the repetition technique, the Good Behavioral Statements help children understand how each group of behaviors belong to a category of desired good behaviors, making it easier for them to learn one good behavior category that can be applied to many real-life situations. In addition the score board is cumulative over time; if during one period of time you added points for lack of compliance with a Good Behavioral Statement, the next period of time the child needs to comply with the Good Behavioral Statement in order to remove the points accumulated from the previous period of time. Another difference is that rewards are given to the child or children with the lowest score, not to every child that has reached an objective in one subject.

U.S. Pat. No. 4,440,396 issued on Apr. 3, 1984 to Rosalie Frudakis, titled “Method for encouraging self improvement”, A board game for encouraging adherence to a self-improvement program, particularly a diet. The game comprises a board depicting a path to a goal and a plurality of playing pieces for each of one or more players, the playing pieces representing stages of development or achievement in the self-improvement program. The playing pieces are adapted to indicate the current positions of the players progressing along the path, and means are provided for rewarding the players for progress toward the goal. Progress toward the dieter's goal is indicated by use of human form playing pieces of progressively slimmer appearance, thereby reinforcing the player's will to succeed. Hazard and benefit spaces are provided along the path, as well as means for soliciting support from others, and for directing the players' frustration toward constructive ends.

In contrast, the presented method doesn't have a path, playing pieces or a primary objective of a dietary goal. In addition, the presented method makes a child spend time learning a Good Behavioral Statement by writing it repeatedly every time they displayed an unwanted behavior, as well as answering the questions “why is it important?” and “what do I need to change in my behavior?”. In addition to the repetition technique, the Good Behavioral Statetments help children understand how each group of behaviors belong to a category of desired good behaviors, making it easier for them to learn one good behavior category that can be applied to many real-life situations.

U.S. Pat. No. 4,201,388 issued on May 6, 1980 to Ruth F. Cantelon, titled “Game apparatus”, A game based upon the religious novel Pilgrim's Progress in which spiritual and moral values are an integral part thereof. A game board is divided into two sections of play and displays a path of travel, as in Pilgrim's Progress, along which the participants each move a marker, with progress along the path being determined by the turn of a spinner/compass, having two levels governing play over the two sections of the display path, or by a pair of dice, governing the direction and duration of diversions from the main path. There are corresponding sets of question and answer cards, with the question cards containing a biblical quotation with key words deleted therefrom and possible answer words provided therebelow, and with the answer cards indicating the correct words to be filled into the quotation. Winners are determined in two ways. One winner is the one whose marker first reaches the end point after traversing the entire path. A second winner is the one having the greatest number of points from play with the question and answer cards.

In contrast, the presented method doesn't have a path, playing pieces, dice, predetermined cards, or a spinner compass. In addition, the presented method makes a child spend time learning a Good Behavioral Statement by writing it repeatedly every time they displayed an unwanted behavior, as well as answering the questions “why is it important?” and “what do I need to change in my behavior?”. In addition to the repetition technique, the Good Behavioral Statements help children understand how each group of behaviors belong to a category of desired good behaviors, making it easier for them to learn one good behavior category that can be applied to many real-life situations.

U.S. Pat. No. 5,470,235 issued on Nov. 28, 1995 to Stephen Papaleo, titled “ Child behavior improvement system”, A child behavior improvement system comprises a support member having a plurality of receptacles for receiving indicia of a reward, multiple discs having indicia defining a reward positioned in each of the receptacles, a cover for covering each receptacle, the cover being at least partially removable for providing access to the reward, and selectable indicia for positioning on the cover for identifying a desirable behavior goal. The present invention relates to education and training and pertains particularly to method and apparatus for enhancing desirable behavior in subjects.

In contrast, the presented method makes a child spend time learning a Good Behavioral Statement by writing it repeatedly every time they displayed an unwanted behavior, as well as answering the questions “why is it important?” and “what do I need to change in my behavior?”. In addition to the repetition technique, the Good Behavioral Statements help children understand how each group of behaviors belong to a category of desired good behaviors, making it easier for them to learn one good behavior category that can be applied to many real-life situations.

In addition, the presented method uses a score system, points are added or removed from each Good Behavioral Statement subject for each child as the child behaves or misbehaves according to the Good Behavioral Statement during a period of time.

In addition, the presented method doesn't reward each child for a specific subject but rewards a child based on the Overall Behavioral Score that adds up all scores from each Good Behavioral Statement. In addition, when several children are participating only the child or children with the lowest Overall Behavioral Score in the Compass is rewarded.

U.S. Pat. No. 4,035,932 issued on Jul. 19, 1977 to Massey; Janet E. , titled “Educational game”, An educational game for school age children designed to teach a variety of essential skills. Players move competitively along a designated path on a playing board according to their correct or incorrect response to a selected one of a plurality of questions dealing with rules of sentence punctuation or any other subject. Each landing area on the designated path includes a plurality of geometric shapes of different colors arranged in a row extending transversely to the path. Because of the unique design of the designated path on the playing board, the game also teaches children to identify colors and geometric shapes, to count, and provides experience in following given directions.

In contrast, the presented method makes a child spend time learning a Good Behavioral Statement by writing it repeatedly every time they displayed an unwanted behavior, as well as answering the questions “why is it important?” and “what do I need to change in my behavior?”. In addition to the repetition technique, the Good Behavioral Statements help children understand how each group of behaviors belong to a category of desired good behaviors, making it easier for them to learn one good behavior category that can be applied to many real-life situations. In addition, the presented method doesn't have a path, playing pieces, dice, predetermined cards, or a playing board. In addition, in the presented method there are no pre-determined responses and the score is accumulated based on the child's behavior not the answers to questions. In addition, in the presented method the goal is not to reach the end of a path but to maintain a low Overall Behavioral Score or an Overall Behavioral Score of 0.

U.S. Pat. No. 8,337,210 issued on Dec. 25, 2012 to Manieri, et al. , titled “Behavior modification device and method”. A behavior modification device and method for encouraging positive behavior and discouraging negative behavior by a child. The device comprises a positive section having a positive receptacle, a neutral section having two receptacles and a negative section having a negative receptacle. Each of the positive and negative sections are made up of members that disconnect to open the receptacles and which separate from the neutral section. Tokens and reward items are placed in the neutral section and a caregiver monitors the child. If good behavior is observed, a token is moved to the positive receptacle. If further good behavior is observed, a second token is moved to the positive receptacle and the child gets a reward item. If bad behavior is observed, a token is moved to the negative receptacle. If further bad behavior is observed, a second token is moved to the negative receptacle and the child is disciplined.

In contrast, the presented method makes a child spend time learning a Good Behavioral Statement by writing it repeatedly every time they displayed an unwanted behavior, as well as answering the questions “why is it important?” and “what do I need to change in my behavior?”. In addition to the repetition technique, the Good Behavioral Statements help children understand how each group of behaviors belong to a category of desired good behaviors, making it easier for them to learn one good behavior category that can be applied to many real-life situations. In addition, in the presented method there are no positive, neutral or negative receptacles, instead a score is accumulated based on the child's behavior.

In addition, in the presented method the goal is not to reach a reward or token for each Good Behavior displayed, but to achieve a low Overall Behavioral Score or an Overall Behavioral Score of 0. In addition when further bad behavior is observed within the specified period of time, the child doesn't accumulate more points against their score but is still sent to spend time learning a Good Behavioral Statement by writing it repeatedly every time they displayed an unwanted behavior, as well as answering the questions “why is it important?” and “what do I need to change in my behavior?”.

U.S. Pat. No. 5,697,790 issued on Dec. 16, 1997 to Antonia Garland , et al. , titled “Discipline system”, A method for a caregiver to teach discipline to a child involves the caregiver selecting a plurality of tokens in response to misbehavior of the child and instructing the child of a suitable token phrase relating to the misbehavior. The child places at least one of the tokens into a first portable container and repeats the token phrase. The child repeats the act of placing the tokens and repeating the token phrase a plurality of times. Another method of disciplining the child is to withhold privileges. Withholding privileges is ineffective with young children, because the punishment is delayed which weakens the association between the misbehavior and the punishment. Also, although sometimes the withheld privilege relates to the misbehavior, often there is no association there between, which can be confusing to small children. Yet another method of disciplining the child is traditional time-out. Traditional time-out involves directing the child to sit alone in a corner, banishment to a room until calm, and other methods of isolation. Although a time-out may help some children to focus on the misbehavior, many children experience difficulty calming down and focusing their thoughts on the misbehavior.

In contrast, the presented method makes a child spend time learning a Good Behavioral Statement by writing it repeatedly every time they displayed an unwanted behavior, as well as answering the questions “why is it important?” and “what do I need to change in my behavior?”. In addition to the repetition technique, the Good Behavioral Statements help children understand how each general group of behaviors falls within a category of Good Behavioral Statement, making it easier for them to learn one Good Behavioral Statement that can be applied to many real-life situations. In addition, the presented method combines the repetition, association, time out for learning purposes, and reward through privileges to the child or children that have the lowest Overall Behavioral Score or an Overall Behavioral Score of 0. In addition, the presented method also provides feedback for displayed good behavior during the specified period of time, by deducting points from their Score Board for each applicable Good Behavioral Statement or subject.

U.S. Pat. No. 5,954,512 issued on Sep. 21, 1999 to David M. Fruge, titled “Behavior tracking board”, A behavior tracking board provides for the recording and monitoring of the general behavior of individuals. The board is particularly well suited for use in families having one or more small children, where it may be used to monitor their behavior over a predetermined period of time (e.g., one week) for the determination of rewards or punishment based upon the behavior for that period. The present tracking board is also adaptable to school and day care environments, and is capable of providing separate behavior monitoring tracks for a large group of children or individuals. Another embodiment is directed to the monitoring of allowance and monetary reward, and is particularly suited for tracking the behavior of teens. The board basically comprises one or more horizontal rows, with each row corresponding to a single individual or child. Each of the rows includes a movable marker captured in a track therealong, with the markers initially each being placed to the extreme right end of their respective tracks. As the time period progresses, the markers are moved leftward along the track when less than desirable behavior by the person being monitored, occurs. Alternatively, markers could initially be centrally positioned, and moved to the right for exemplary behavior and to the left for less than desirable behavior. Various means of hanging or supporting the board are also disclosed, as well as a method of monitoring behavior using the present board.

In contrast, the presented method makes a child spend time learning a Good Behavioral Statement by writing it repeatedly every time they displayed an unwanted behavior, as well as answering the questions “why is it important?” and “what do I need to change in my behavior?”. In addition to the repetition technique, the Good Behavioral Statements help children understand how each general group of behaviors falls within a category of Good Behavioral Statement, making it easier for them to learn one Good Behavioral Statement that can be applied to many real-life situations. In addition, the presented method combines the repetition, association, time out for learning purposes. In addition, the presented method uses points instead of a marker on a track, and the starting score for each period of time per Good Behavioral Statement is the score from the last period of time, thru points are associated from one period of time to the next.

In addition, the presented method tracks behaviors specific to Good Behavioral Statements, instead of tracking only overall behaviors. This helps the child focus on which areas or subjects they need to improve on. In addition, the presented method is perpetual as points are carried over from one period of time to the next period of time, whereas the tracking board presented in U.S. Pat. No. 5.954.512 is presented as a behavioral tracking board to monitor behavior over a predetermined period of time. In addition, when several children participate the presented method rewards only the child or children that have the lowest Overall Behavioral Score on the Compass or all children with an Overall Behavioral Score of 0, whereas the tracking board presented in U.S. Pat. No. 5.954.512 rewards each child for achievements or improvements.

U.S. Pat. No. 2,414,614 issued on Jan. 21, 1947 to Edward P. Shurick, Sr., titled “Children's Behavior Indicator,” comprises a board having a plurality of horizontal channels formed therein. Each of the channels contains a slide which may be advanced along the corresponding channel during the course of a week, according to the behavior of the child corresponding to the particular slide. A coin or the like is deposited at the end of each slide, to drop from the board when the slide reaches the far end of its travel and pushes the coin from the board. Shurick, Sr. provides no additional reward for exceptional behavior or for additional behavioral performance, as is provided by the present behavioral tracking board. Moreover, the Shurick, Sr. board has no provision for indicating any punishment for bad behavior, which punishment indication means is provided by the present board. Movement of the indicators of the present board is not based upon any particular time period (e.g., per day, as with Shurick, Sr.), but instead is based upon behavior, with the indicators being moved according to the children's behavior at any given point. The present board assumes good behavior, with no indicator movement being required should such good behavior prove to be the case for the period in question.

In contrast, the presented method makes a child spend time learning a Good Behavioral Statement by writing it repeatedly every time they displayed an unwanted behavior, as well as answering the questions “why is it important?” and “what do I need to change in my behavior?”. In addition to the repetition technique, the Good Behavioral Statements help children understand how each general group of behaviors falls within a category of Good Behavioral Statement, making it easier for them to learn one Good Behavioral Statement that can be applied to many real-life situations.

In addition, when several children participate the presented method rewards only the child or children that have the lowest Overall Behavioral Score on the Compass or all children with an Overall Behavioral Score of 0, whereas the indicator presented in U.S. Pat. No. 2,414,614 provides no reward system.

U.S. Pat. No. 3,782,009 issued on Jan. 1, 1974 to Eula K. Darnell, titled “Behavior Modification Point Board,” comprises a board having a plurality of row and column slots therein. A leftmost column provides for the names of a plurality of students, while an upper row provides a list of desirable traits, habits, tasks to be completed, etc. A marker is placed within the corresponding slot whenever a student completes one of the upper row items satisfactorily. The markers are later exchanged for a reward of some sort.

In contrast, the presented method makes a child spend time learning a Good Behavioral Statement by writing it repeatedly every time they displayed an unwanted behavior, as well as answering the questions “why is it important?” and “what do I need to change in my behavior?”. In addition to the repetition technique, the Good Behavioral Statements help children understand how each general group of behaviors falls within a category of Good Behavioral Statement, making it easier for them to learn one Good Behavioral Statement that can be applied to many real-life situations. In addition the score board is cumulative over time; if during one period of time you added points for lack of compliance with a Good Behavioral Statement, the next period of time the child needs to comply with the Good Behavioral Statement in order to remove the points accumulated from the previous period of time. Another difference is that rewards are given to the child or children with the lowest Overall Behavioral Score, instead of every child that has tokens because they have reached an objective in one subject.

In addition, No time period is specified with the Darnell board, as only two variables can be provided for (in this case, the names of the students and the tasks). No additional rewards are provided for exceptional behavior, nor is any punishment provided for poor behavior, as provided by the present board.

U.S. Pat. No. 5,573,404 issued on Nov. 12, 1996 to Willard S. Stawski, II, titled “Device and process for modifying behavior of children”, A behavior modification device and process comprises a recording implement having a group of interrelated columnar items of a person's behavior, with an assigned monetary value to each of these. The columns are laterally and vertically aligned so that the person has a running view of a summary of the effect of his behavior during a stated period. The device is constructed as a sheet of printable paper or plastic material secured in place by magnetic attachment to a refrigerator door, or to some similar available surface where the family traffic is relatively dense. The device, when completed for the stated period, can be used as a basis for the payment of allowances.

In contrast, the presented method makes a child spend time learning a Good Behavioral Statement by writing it repeatedly every time they displayed an unwanted behavior, as well as answering the questions “why is it important?” and “what do I need to change in my behavior?”. In addition to the repetition technique, the Good Behavioral Statements help children understand how each general group of behaviors falls within a category of Good Behavioral Statement, making it easier for them to learn one Good Behavioral Statement that can be applied to many real-life situations. In addition the score board is cumulative over time and not associated to monetary allowances but rewarded with privileges doe to good behaviors or privileges removed due to bad behaviors.

U.S. Pat. No. 5,725,381 issued on Mar. 10, 1998 to Richard Craig Kollath, et al. , titled “Motivation system for children”, A motivation system for children is provided, which consists of a motivation system board, play money of various denominations, and coupons for various predefined rewards. The motivation system board consists of a flat rectangular rigid sheet with a schedule information area, a rewards information area, and an erasable felt tip marking pen with a pen holder. The schedule information area contains a first column for listing the time of day, a second column for listing the behavior the child is to perform, and a third column for listing the quantity of play money to be received by the child. The rewards information area contains a first column for listing rewards that may be purchased, and a second column for listing the play money purchase price of reward.

In contrast, the presented method makes a child spend time learning a Good Behavioral Statement by writing it repeatedly every time they displayed an unwanted behavior, as well as answering the questions “why is it important?” and “what do I need to change in my behavior?”. In addition to the repetition technique, the Good Behavioral Statements help children understand how each general group of behaviors falls within a category of Good Behavioral Statement, making it easier for them to learn one Good Behavioral Statement that can be applied to many real-life situations. In addition the score board is cumulative over time and not associated to monetary allowances but rewarded with privileges doe to good behaviors or privileges removed due to bad behaviors.

None of the above inventions and patents, either singly or in combination, is seen to describe the instant invention as claimed.

### BRIEF DERIPTION OF THE DRAWINS

For the purpose of illustrating the Board presented in claim 2 used with the invention according to claim 1, there are shown in the drawings forms which are presently preferred; it being understood, however, that this invention is not limited to the precise arrangements and instrumentalities shown.

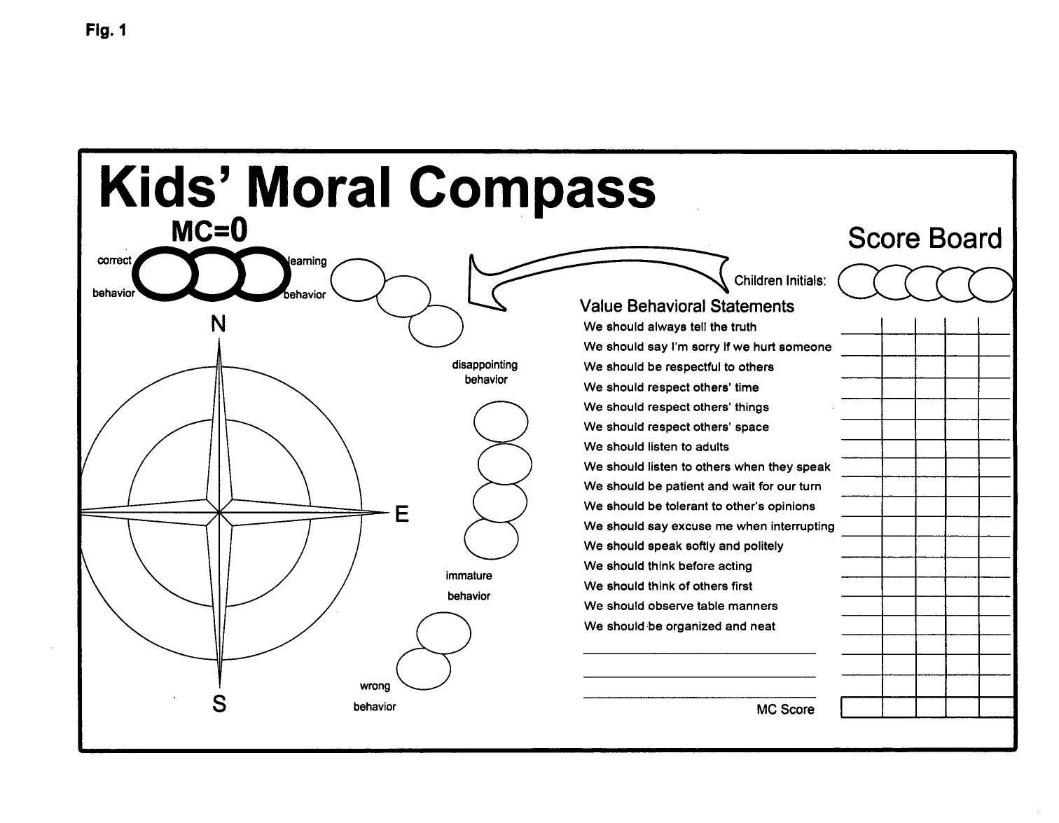

FIG. 1. is a plan view of the board of the first embodiment of the presented board in claim 2, showing its various features, to be used for the educational method according to claim 1.

FIG. 1 shows the behavioral scores for each child for each behavioral statement, the children overall behavioral score tracking, and the points' meter elements of the board. The points' meter is referred to as the “Moral Compass” and it has 3 elements: 1) the Compass, 2) the ellipses to display the children's initials, and the five behavioral levels. The five behavioral levels are Correct Behavior, Learning Behavior, Disliked Behavior, Immature Behavior, and Wrong Behavior.

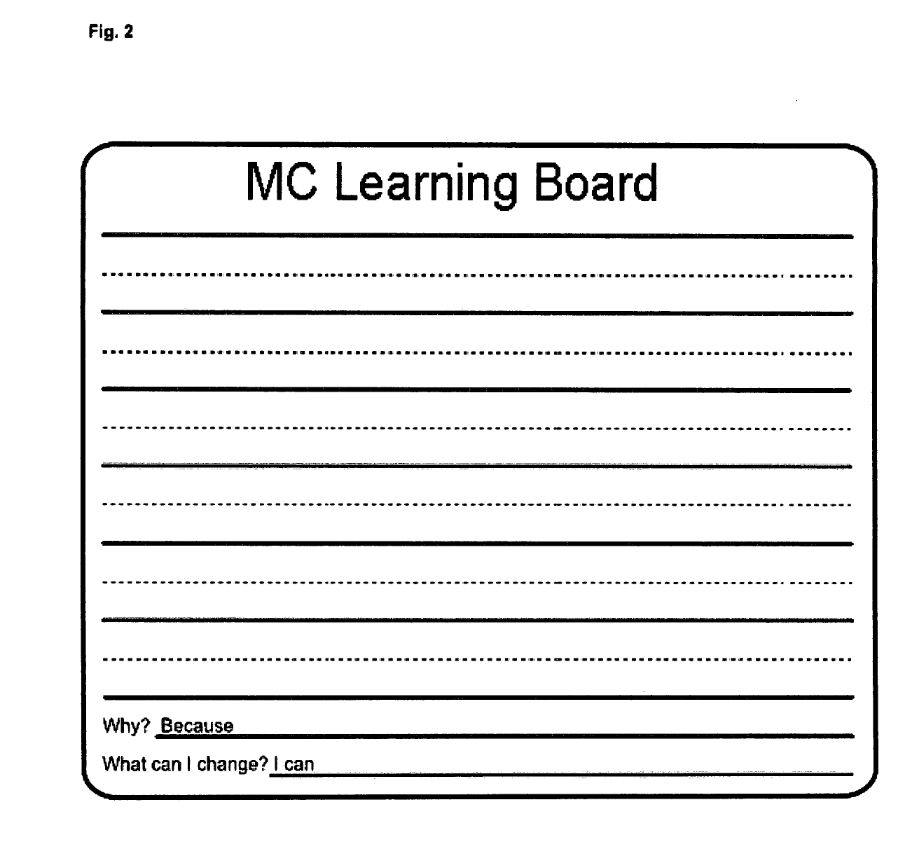

FIG. 2 is a plan view of another element of the board of the first embodiment of the board of the presented board in claim 2, showing its various features. This part of the board is to be used for the learning assignment in the educational method according to claim 1, steps (a), (b), and (c).

### DETAILED DESCRIPTION OF THE INVENTION

The present invention compromises a method and a board to educate children by means of writing in the board a Good Behavioral Statement numerous times, explaining why that Good Behavior is important, why their behavior is not right, and how they can improve their behavior moving forward by applying the Good Behavioral Statement they have written and learned. The number of times the Good Behavioral Statement will be written will be determine by the severity of the action or bad behavior. Once the child has written the Statements and explained why their behavior needs to change, the parent or care giver will sit down with the child to discuss the subject at hand.

Once the subject has been discussed points will be assigned to that child in a scoreboard. This scoreboard adds up the total points that a child has accumulated for bad behavior, adding up to the total “Moral Compass Score” (the Score).

The more points a child has the further they are from the right behavior, Score 0.

Points can be subtracted from the scoreboard when a child has followed a Good Behavioral Statement, thus reducing the overall Score for that child. Points are added to the scoreboard when a child displays bad behavior associated to a Good Behavioral Statement, thus increasing the overall Score for that child. Points are accumulated for each Good Behavioral Statement when a bad behavior is repeated.

Every period of time each child has the opportunity to discount points from their Score by following a Good Behavioral Statement during that period of time. When a child behaves properly according to one of the Good Behavioral Statements, and that child had points in her Score Board accumulated against that Good Behavioral Statement, points are discounted from the scoreboard.

Every period of time when a child behaves improperly according to any of the Good Behavioral Statements, points are added to the scoreboard's points for that Good Behavioral Statement.

A reward system is applied to the scoreboard so that children that improve their behavior or maintain good behavior will be rewarded. The reward can be predetermined or assigned by the parent or care giver periodically.

### DETAIL DESCRIPTION OF THE PREFERRED EMBODIMENTS

The present invention is not necessarily limited to the various board apparatus discussed further above. The present invention lends itself well to be applied using conventional hand recording means for keeping score (pencil and paper, chalk board, etc.). In such cases, the appropriate number of points are added to (or subtracted from, in accordance with the rules) each child's score. Thus, the present invention may be applied in a home or other environment, or may be played in a situation not conducive to setting up a game board, such as in a moving automobile or other travel scenarios.

The Kids' Moral Compass Board presented in FIG. 1 has two parts: the Moral Compass and the Score Board.

The Learning Board presented in FIG. 2 is used to complete the learning assignments per the process.

The Moral Compass in FIG. 1. Acts as navigational tool, directing children to the desired behavior. Kid's initials are displayed next to the Compass in order according to their MC Score, or overall behavioral score. The kids with the lowest scores have their initials at the top, and the children with the highest score have their initials towards the bottom of the score, listed in the order explained below. Initials show the kid's distance from the Correct Behavior in the Compass' North (0 points), and in a corresponding behavioral level.

The Score Board in FIG. 1. Consists of a list of Universal Behavioral Statements and the current score for each child for each Statement. Under each child's initials you keep track of their points for each behavioral statement, and their Overall Behavioral Score, or “MC Score”. There is also space for you to add your own Behavioral Statements.

The Learning Board in FIG. 2. This board is used by a child to complete a learning assignment of learning a value because they have behaved improperly. The child maintains attention on the subject, which facilitates the process of encoding the information in their brain and long-term memory.

The Kids' Moral Compass Method. Following All the Guidelines for the Moral Compass Method will result in noticeable advances in the right direction for the behaviors to be addressed, and gain control over hard-to-handle kids' behaviors.

The educational method according to claim 1 can be used in any environment with one or more children on writing age between 5 and 12 years.

For the educational method according to claim 1 points are added to the Score Board in FIG. 1 thought the day when children display bad behaviors, and they have to complete a learning assignment. Kids also have a chance to remove points from their Score Board in FIG. 1 by displaying good behaviors during a whole day. All the accumulated points add up to each child's Overall Behavioral Score, called the MC Score. The MC Score limits the privileges they get.

When to Add Points? The First Time Rule: The first time of the day that a child gets a learning assignment for a specific Behavioral Statement, we add points to that child's Score Board by that specific Statement.

When to Remove Points? The End of the Day Rule: At the end of each day, if a child already had any points related to a Behavioral Statement from previous days, and they followed that Behavior Statement during that day, we remove points in the Score Board for that Statement.

IMPORTANT NOTE: Each child can have point either added or removed once a day for each Value Statement.

How Many Points do We Add or Remove each Time? Children always get added or removed the same set of points: their age. 7 points for a 7 years old, 5 points for a 5 years old, etc.

A Bad Behavior Always Leads to a learning assignment. Through the day if a kid displays a bad behavior we always follow this learning assignment process using the learning board in FIG. 2:
1. The adult takes that child to the MC Board:
1.a. Chooses the Behavioral Statement that describes the desired behavior,
1.b. Depending on the severity of the behavior, chooses the number of times the child will write that Statement (Using their age number as a multiplier so a 7 years old will get either 7, 14, 21 times, etc.)
2. The child uses the MC Learning Board, or a separate notebook:
2.a. Writes the Behavioral Statement the number of times chosen,
2.b. Comes up with a reason, and writes or explains, why their good behavior is important.
2.c. Comes up with a reason, and writes or explains, what they need to change in their behavior.
3. The child will show the board to the adult.
4. The adult and child will discuss the importance of the Behavioral Statement, the why, and the what.
5. You add points to the Score Board when applicable per the First Time Rule explained above.
6. If the child used the learning board he or she should erase the area before being dismissed.

Guideline: The child must stay quiet, without communicating, and not moving from the designed area until completed.

### Kids Objective

On the first day all kids' MC Score=0, referred to as MC=0, meaning they have 0 points. The kid's objective is to maintain their MC Score=0, or have the lowest Score on the Score Board to gain privileges.

### The Overall Behavioral Score (or MC Score)

Children's MC Scores are calculated by totaling all the points in that child's column in the Score Board in FIG. 1. Then the children's initials are displayed next to the Compass from the top down, and in scoring order.

At the top of the Moral Compass we write the initials with the lowest score, then writing all initials in scoring order until we write the initials of the child with the highest score at the bottom of the list. Initials displayed must follow this scoring order, but the initials don't need to be right next to each other. A child's initials may be listed lower in the Compass, next to the behavioral level we feel appropriate for their current score and behavior. If we lower the initials in the Moral Compass for one child, the initials of children with higher scores must still be listed below that child's initials.

When to recalculate the MC Scores?
1. When points are added to a child's Score Board during a learning assignment per the First Time Rule, the MC Score for that child is reviewed.
2. At the end of each day MC Scores are reviewed per the End of the Day Rule, except for Children that have a Score MCO.
2.a. For each child review each Statement with points in the Score Board under the child's initials.
2.a.1. If the child followed that Behavioral Statement during the day we remove one set of points; for example if a child has 14 points in a Statement we would remove 7 and leave 7 on their Score Board.
2.a.2. If during the day they behaved badly in regards to that Statement we don't remove or add anything at this point, because we already did it during the day's first assignments.
2.b Once completed we add up each child's points to update their MC Scores on top of their initials, then realign each child's initials in the Moral Compass.

The Reward for a MCO or the lowest MC Score is privileges. Once the children's initials are realigned around the compass, the child that has the lowest MC Score gets a set of predetermined privileges for the next day. Tied scores receive the same set of privileges. The rest of the kids with higher MC Scores get those privileges removed for the day.

Through the day kids with privileges may earn new points. Upon review, their Scores may add up higher than other kid's MC Score. When this happens the privileges for the rest of the day get transferred to the kid with the lowest MC Score.

Guideline: When teaching the Guidelines explain to all the kids the full list of privileges for whomever has the lowest MC Score. Mention a few specific privileges like playing computer games, watching TV, or sitting at the favorite chair during dinner. Also provide a few more general like having food and drinks privileges, etc.

These Guidelines are very important as they help you gain control of situations, speed up the learning process, and create a framework of trust:
1. PRAISE: Through the day praise good behaviors and get kids excited about reducing points and possibly gaining ‘MCO Status’. They will embrace it as a game and get competitive to have the privileges back, or stay as ‘MCO’.
2. PREVENT: Most behaviors have triggers, and they are easy to identify. Each Value Statement has a bold Key Value for you to use when you see a trigger. For example saying this before nap time “Remember to Respect other's time while your brother naps” will help your child remember and prevent the bad behavior.
3. BE STERN: Give only one reminder and one warning before an assignment. If they don't want to do the learning assignment keep them on time out until they finish it.
4. LEAD BY EXAMPLE: Your children will believe you when they see you endorse the correct behaviors.
5. DONT NEGOTIATE: Once you set a learning assignment it needs to be completed, always. Tell the child that you can discuss it once the assignment is done.
6. DONT ARGUE: If your child says “she did it to me before”, you say “Next time you tell me instead of reacting, and she will get the Assignment. Let's talk about it when you are done with the Assignment.”
7. BE SPECIFIC: The why has to be specific to the bad behavior. “Because I need to respect others” is not acceptable, “because I can hurt people” is acceptable.
8. ALWAYS USE IT: We recommend you still apply the MC Method outside of the MC environment, learning assignments and points can be completed later when you get home.
9. NUMBER OF LINES: Depends on the age and importance of the matter. For a 7 years old start with 7 lines and move up to 14, 21, and 28 if the situation worsens.
10. DONT OVERWELM: Start by giving a learning assignments for the two or three most frequent bad behaviors you want to modify. This technique will keep child within reasonable reach of ‘MCO’ points on any given day. Too many points will discourage them to keep trying.
11.IT'S EASY! Don't overheat the situation with frustration. It's very easy to remove from the situation the kid with the bad behavior, and have them focused and sitting until they finish the assignment.

Examples of behaviors we want to stop with each Behavioral Value Statement:
“We should always tell the truth”. To stop lying, hiding information, being an accomplice, etc.
“We should say I'm sorry after hurting someone”. To stop rudeness, lack empathy, etc.
“We should be respectful to others”. To stop repeated verbal behavior that shows lack of respect, etc.
“We should respect others' space”. To stop bullying, pushing, keeping close counters, hitting, etc.
“We should respect others' time”. To stop not respecting nap, study, bed, or TV time, interruptions to other's conversations, etc.
“We should respect others' opinions”. To stop bullying, laughing at someone, put downs, etc.
“We should respect others' things”. To stop not asking for permission, not taken care of properly, etc.
“We should listen to adults”. To stop kids not paying attention to you, repeating behaviors after telling them what to do or not do, etc.
“We should listen to others when they speak”. To stop cutting off people when they talk, turning their backs on adults, etc.
“We should speak softly and politely”. To stop screaming, yelling, talking too loud, etc.
“We should follow table manners”. To stop chaos while at the table, rude comments, etc. “We should be patient”. To stop repeating the same questions when you don't answer, not saying ‘excuse me’ when interrupting, etc.

It should be understood that the present invention is not limited to the exact devices and instrumentalities described herein. Additional embodiments of the present inventive concept will now be apparent to those skilled in the art.

Accordingly, reference should be made to the appended claims rather than the foregoing Specification as defining the true scope of the subject invention.

1. An educational method that teaches children by means of following the next steps:
(a) Have children to repeatedly write or orally recite numerous times a predetermined Good Behavioral Statement we want them to learn when they display unwanted behaviors as it relates to any of the predetermined Good Behavioral Statements;
(b) Have children explaining in writing or orally the benefits of following the Good Behavioral Statement;
(c) Have children explaining in writing or orally what are they going to change in their behavior;
(d) Have children explaining in writing or orally why their behavior needs modification, and why the unwanted behavior needs to be changed;
(e) Adding points to a child's score board for a Good Behavioral Statements when they have displayed unwanted behavior during a period of time as it relates to that Good Behavioral Statement.
(f) Deducting points from each child's score board for a Good Behavioral Statements when they have displayed desired behavior during a period of time as it relates to a Good Behavioral Statements on the board.
(g) Keeping track of children's specific behavior for each specific Good Behavioral Statement subject, as well as the child's Overall Behavioral Score for a specific period of time by adding all the current scores from each Good Behavioral Statement.
(h) Reviewing the score for each child at the end or beginning of every period so they are aware of their starting score for the next period for each Good Behavioral Statement, and their starting Overall Behavioral Score; Reviewing on which Good Behavioral Statements they can improve on and discount points during the next period of time due to good behavior; And explaining who is getting rewarded during the current period for having the lowest Overall Behavioral Score or for lowering their Overall Behavioral Score.
(i) Following a reward system in which only the child or children that have the lowest Overall Behavioral Score(s) at the beginning of a period of time gets the reward during that period of time. If only one child is participating the child only gets rewards during that period of time when the child has a lower Overall Behavioral Score than in the previous period of time. The child or children with the lowest Overall Behavioral Score are rewarded by allowing them to certain predetermined privileges. The rest of the children can't have access to the predetermined privileges during that period of time, and will only be able to access those predetermined privileges by attaining the lowest score again.
(j) Using a Compass or a Points' Meter to 1) display how each child's overall score is against the rest of the children's overall scores, and 2) showing the children's points against their corresponding overall behavioral level.

2. In one embodiment the board used in the educational method according to claim 1 is designed as a writing board with various elements, to be used every time a child displays an unwanted behavior to be modified.

3. Other uses of the writing board according to claim 2 related to the intended educational method according to claim 1 may include but are not limited to keeping track of usage, reasons, count, dates, or rewards associated to each child that has used the board according to claim 2.

4. In one embodiment the writing board according to claim 2 used for the educational method according to claim 1 is a thin table mat.

5. In different embodiments the writing board according to claim 2 used for the intended educational method according to claim 1 may be a vinyl mat, dry-erase board, dry-erase mat, note book, sheet of paper, chalk board, paper mat, computer application, any type of electronic device or display, software, or a combination of any of them.

6. In other embodiments the writing board according to claim 2 used for the educational method according to claim 2 has magnets to hang on a refrigerator, wires to hang off the wall, peel and stick, or other means of support.

7. In any of the embodiments according to claim 2, 4, 5, or 6, for the educational method according to claim 1, the method to keep track of a child's behavioral progress is a compass or other type of meter for points.

8. In any of the embodiments according to claim 2, 4, 5, or 6, for the educational method according to claim 1, the compass used according to claim 7 is referred to as the “Moral Compass”.

9. The educational method according to claim 1 can be implemented by using other means of information, such as idioms, idiomatic expressions, quotes, popular phrases, or popular sayings, instead of the Behavioral Statements.

10. The educational method according to claim 1 can be applied to teach values to people of any age.
